(19) United States
(12) Patent Application Publication
(10) Pub. No.: US 2025/0271667 A1
(43) Pub. Date: Aug. 28, 2025

(54) COMPOSITE PANE FOR A PROJECTION ASSEMBLY

(71) Applicant: SAINT-GOBAIN GLASS FRANCE, COURBEVOIE (FR)

(72) Inventors: Andreas GOMER, HERZOGENRATH (DE); Stefan HERTEL, HERZOGENRATH (DE)

(21) Appl. No.: 18/862,374

(22) PCT Filed: Apr. 26, 2023
(86) PCT No.: PCT/EP2023/060880

§ 371 Date: Nov. 1, 2024

(30) Foreign Application Priority Data
May 3, 2022 (EP) 22171396.9

(51) Int. Cl. G02B 27/01; G02B 27/28

(52) U.S. Cl. CPC G02B 27/0101; G02B 27/28; G02B 2027/0194

(57) ABSTRACT

A composite pane for a projection assembly includes a first pane, a second pane, a thermoplastic intermediate layer, wherein the first pane is joined to a second pane via an intermediate layer to form a composite pane, and wherein the first pane has a first surface facing away from the thermoplastic intermediate layer and a second surface facing the thermoplastic intermediate layer, and the second pane has a first surface facing the thermoplastic intermediate layer and a second surface facing away from the thermoplastic intermediate layer, and a mirror structure with electrically switchable optical properties, wherein the mirror structure is arranged in front of an opaque masking strip in the through-vision direction through the composite pane.

The invention relates to a composite pane for a projection assembly and a projection assembly.

Motor vehicles have, in the interior, head-up displays (HUDs) that project vehicle and traffic information onto a windshield. This information can be read by the vehicle driver without diverting his attention from the flowing traffic. Usually, vehicle windshields consist of two glass panes that are laminated to one another via at least one thermoplastic film. The radiation of an HUD projector is typically substantially s-polarized. This has to do with the better reflection characteristics of the windshield for s-polarized light compared to p-polarized light. However, if the driver wears polarization-selective sunglasses that transmit only p-polarized light, he can hardly perceive the HUD image, or not at all. There is, consequently, a need for HUD projection assemblies that are compatible with polarization-selective sunglasses. A solution of the problem in this connection is, consequently, the use of projection assemblies that use p-polarized light.

DE 102014220189A1 discloses an HUD projection assembly operated with p-polarized radiation to generate an HUD image. Since the angle of incidence is typically close to Brewster's angle and p-polarized light is therefore reflected only to a small extent by the glass surfaces, the windshield has a reflective structure that can reflect p-polarized light in the direction of the driver. A single metallic layer with a thickness from 5 nm to 9 nm, for example, made of silver or aluminum, which is applied on the outer side of the inner pane facing away from the interior of the passenger car, is proposed as the reflective structure.

When designing a projection assembly based on HUD technology, care must further be taken to ensure that the projected image is readily recognizable by the viewer. Sufficient visual perceptibility of, in particular, safety-relevant information, such as lane guidance, speed display, or engine speed should be ensured under all weather and lighting conditions. For example, it would be desirable to have a projection assembly based on head-up display technology and with which no undesirable secondary images occur and whose arrangement is relatively easy to implement with good recognizability with sufficient brightness and contrast of the image information displayed. Furthermore, the projection assembly should be simple and economical to manufacture.

Known from DE 10 2006 006 690 B4 is an antiglare device designed as a sun visor that is movably arranged on an object in an interior of a vehicle. The antiglare device has a light-permeable subregion with a functional layer whose light transmissivity can be altered.

WO 2021/139995 A1 discloses a vehicle glazing and display system inside a bus for projecting images on a partition window of the bus.

The object of the present invention consists in providing an improved composite pane for a projection assembly.

This object is accomplished by the invention disclosed in the independent claims. Preferred embodiments emerge from the subclaims.

The composite pane according to the invention for a projection assembly comprises at least a first pane, a second pane, a thermoplastic intermediate layer, wherein the first pane is joined to the second pane via the intermediate layer to form a composite pane. The first pane has a first surface (IV) facing away from the thermoplastic intermediate layer and a second surface (III) facing the thermoplastic intermediate layer surface (III). Likewise, the second pane has a first surface (II) facing the thermoplastic intermediate layer and a second surface (I) facing away from the thermoplastic intermediate layer. In addition, the composite pane comprises a mirror structure with electrically switchable optical properties. In particular, the mirror structure has reflecting properties that are electrically switchable. For this purpose, the mirror structure can have two flat control electrodes. Because the fact that the composite pane has a mirror structure, a good image display with high contrast of images cast onto the composite pane is achieved. The images reflected by the mirror structure appear bright and thus very readily recognizable.

The mirror structure can be arranged on the first pane. In this case, the mirror structure can be mounted between the first pane and the thermoplastic intermediate layer. Alternatively, the mirror structure can be mounted on the first surface (IV) of the first pane, enabling particularly simple production. Here, “arranging” is understood to be both direct arranging of the mirror structure on the pane and indirect arranging on the pane. For example, at least one further layer can be arranged between the pane and the mirror structure. By arranging the mirror structure on the first pane, the light of an image display device directed at the first pane can be reflected very well.

In a preferred embodiment, the mirror structure can be arranged in an edge region of the composite pane. If the mirror structure is arranged in an edge region, then, preferably in the vicinity of an edge, in particular the lower edge, of the composite pane. A distance of the mirror structure from the edge of the first pane is preferably from 0.1 cm to 30 cm, particularly preferably from 1 cm to 15 cm, and in particular from 5 cm to 10 cm. Arranging the mirror structure in an edge region is particularly suitable, since, in many possible applications of composite panes, the through-vision region is usually situated in a central region of the composite pane. Thus, even when a mirror structure is switched on in the semitransparent (partially reflecting) or completely reflecting state, through-vision is not impaired.

When viewed in the through-vision direction through the composite pane starting from the first pane, the mirror structure is arranged in front of an opaque masking strip, with the opaque masking strip acting as an opaque background and being arranged, in some regions, at least on one of the surfaces (III, IV) of the first pane and/or the surfaces (I, II) of the second pane. Thus, a good high-contrast image display of images cast onto the composite pane is achieved. The images reflected by the mirror structure are reflected particularly brightly and are thus quite readily recognizable.

The mirror structure and the opaque masking strip can be separated from one another by the intermediate layer and/or by the first pane. The distance between the mirror structure and the masking strip can be less than 3 mm. With a distance of less than 3 mm, very clear reflection images are obtained.

In another preferred embodiment, the mirror structure is protected by a protective layer. In other words, a hydrophobic film is arranged as a protective layer at least on the first surface (IV) of the first pane and seals the surface of the mirror structure coated therewith against the surrounding atmosphere. The protective layer provided thus forms, at least in the region of the mirror structure, the first, outer surface of the composite pane directed toward an interior in the installed position, and advantageously protects it, in particular the mirror structure, against external influences, in particular contamination. As a hydrophobic film, the protective layer is a coating with good resistance to deposits of, for example, liquids, salts, greases, and dirt and is advantageously particularly easy to clean. For example, the creation of fingerprints from touching by an occupant/user can be avoided. Hydrophobic films suitable according to the invention, as well as their design and production, are described, for example, in WO2005/084943, WO2007/012779, or WO2010/079299. Such hydrophobic coatings are already applied and used, for example, on the outer side of the outer pane of vehicles. In this use, such hydrophobic films have good durability of two or more years. As a result of the hydrophobic coating, water droplets simply slide off the glazing, which can provide the driver better vision through a windshield when it rains. Advantageously, the use according to the invention of the hydrophobic coating on the mirror structure of the composite pane results in the fact that the mirror structure is not directly exposed to weathering or to friction from windshield wipers and thus has extended durability. Advantageously, however, the coating according to the invention is also easy to restore.

In a further embodiment, the mirror structure is implemented contiguously flat. This has the advantage that the associated water and dirt repellent properties of the hydrophobic film can also be provided over the entire surface. In addition, the production of such a full-surface seal toward an interior is also simple, efficient, and economical to implement.

Preferably, the mirror structure has alterable reflection. In the switched-on state, the reflectivity of the mirror structure can equal that of a metal/glass mirror; and, in the switched-off state, there is virtually no reflection. The mirror structure according to the invention can be switched from an, in particular, optically transparent state (i.e., a “non-mirroring” state) to a semitransparent state or to a reflecting state (mirroring state). The semitransparent state is an intermediate state between the transparent and the reflecting state such that the mirror structure can be dimmed. Thus, the brightness of the reflected images can be altered. For this purpose, an electrical voltage is applied at two connection points of the mirror structure. Consequently, the mirror structure is particularly suitable as a mirror whose reflectivity is intended to be alterable, such as a vehicle mirror or architectural glazing.

Preferably, a user himself (for example, a vehicle occupant) can select the state of the mirror structure as he wishes or requires. A switch or a dimmer can be used for this. However, the mirror structure can also be automatically switchable.

The mirror structure is preferably implemented as a mirror film. This has the advantage that the mirror film can be used and handled particularly well in a manufacturing process of the composite pane.

The opaque masking strip, which is arranged in some regions at least on one of the surfaces (I, II, III, IV) of the composite pane, can, in principle, be arranged on each pane side of the first or the second pane. In the composite pane according to the invention, it is preferably applied on the first surface (II) of the second pane, where it is protected against external influences. Alternatively, or additionally, a masking strip can preferably be provided on the first surface (IV) of the first pane.

The masking strip is preferably a coating comprising one or a plurality of layers. Alternatively, however, it can also be an opaque element inserted into the composite pane, for example, a film.

According to a preferred embodiment of the composite pane, the masking strip consists of a single layer. This has the advantage of particularly simple and economical production of the composite pane, since only a single layer has to be formed for the masking strip.

In particular, in the case of a windshield, the masking strip serves to mask an adhesive bead for gluing the windshield into a vehicle body. This means it prevents viewing the usually irregularly applied adhesive bead from the outside such that a harmonious overall impression of the windshield is created. On the other hand, the masking strip serves as UV protection for the adhesive used. Continuing irradiation with UV light damages the adhesive and, over time, would loosen the bond of the pane to the vehicle body. In the case of panes with an electrically controllable mirror structure, the masking strip can, for example, also be used to conceal bus bars and/or connection elements.

The masking strip is preferably printed onto the second pane and/or the first pane, in particular by screen-printing. The printing ink is pressed through a fine-meshed fabric onto the glass pane. The printing ink is, for example, pressed through the fabric with a rubber squeegee. The fabric has regions permeable to the printing ink in addition to regions impermeable to the ink, which define the geometric shape of the print. The fabric thus acts as a stencil for the print. The printing ink contains at least one pigment and glass frits suspended in a liquid phase (solvent), for example, water or organic solvents such as alcohols. The pigment is typically a black pigment, for example, carbon black, aniline black, bone black, iron oxide black, spinel black, and/or graphite.

After the ink is printed, the glass pane is subjected to a temperature treatment in which the liquid phase is expelled by evaporation and the glass frits are melted and permanently bonded to the glass surface. The temperature treatment is typically carried out at temperatures in the range from 450° C. to 700° C. The pigment remains as a masking strip in the glass matrix formed by the molten glass frits. The masking strip preferably has a thickness of 5 μm to 50 μm, particularly preferably of 8 μm to 25 μm.

In principle, the masking strip can, as already described, be arranged on any pane side of the first pane or the second pane. In a composite pane according to the invention, this is preferably applied to the first surface (inner side) II of the second pane (outer pane) in the installed position, where it is protected against external influences.

Another embodiment provides that, alternatively, or additionally, a masking strip is arranged as a ceramic black print on the first surface (IV) of the first pane, which can, in particular, improve the application of adhesive layers and the quality of the adhesive bonds, in particular in the installation of the composite pane according to the invention, for example, in a vehicle. In other words, the opaque masking strip is preferably arranged as a ceramic black print on the first surface (IV) of the first pane at least in an edge region, for example, as a circumferential edge region, of the composite pane.

Alternatively, the masking strip is a colored or pigmented, preferably black pigmented, thermoplastic composite film, preferably based on polyvinyl butyral (PVB), ethyl vinyl acetate (EVA), or polyethylene terephthalate (PET), preferably PVB. The coloring or pigmentation of the composite film can be freely selected, but is preferably black. The colored or pigmented composite film is preferably arranged between the first pane and the second pane. The colored or pigmented thermoplastic composite film preferably has a thickness of 0.25 mm to 1 mm. Preferably, the colored or pigmented composite film extends over a maximum of 50% and particularly preferably a maximum of 30% of the surface of the composite pane. In order to avoid thickness differences in the composite pane, a transparent further thermoplastic composite film is arranged between the first pane (e.g., an outer pane) and the second pane (e.g., an inner pane), which extends over at least 50%, preferably at least 70%, of the surface of the composite pane. The colored or pigmented composite film is arranged in the surface plane of the composite pane offset from the transparent thermoplastic composite pane such that they do not overlap or coincide.

The masking strip can also be provided by a thermoplastic composite film pigmented or colored in some areas. In this case, the mirror structure is arranged in the through-vision region spatially in front of the pigmented or colored area of the thermoplastic composite film. The pigmentation or coloring of the composite film preferably extends over an area of at most 50% and particularly preferably of at most 30% of the surface of the composite pane. The remaining part of the thermoplastic composite film pigmented or colored in some areas is transparent, i.e., implemented without pigmentation or coloring. The thermoplastic composite film pigmented or colored in some areas preferably extends over the entire surface of the composite pane. Implementing the masking strip as a pigmented or colored thermoplastic composite film or as a thermoplastic composite film pigmented or colored in some areas simplifies the production of the composite pane and improves its stability. It is very advantageous for the first pane (inner pane) or the second pane (outer pane) not to have to be coated in advance in order to create an opaque background. For one thing, this increases the stability of the composite pane and, also, improves process efficiency.

The terms “first pane” and “second pane” are selected to distinguish between the two panes in a composite pane according to the invention. No statement concerning the geometric arrangement is associated with the terms. If, for example, the composite pane according to the invention is provided in an opening, for example, of a vehicle or of a building to separate the interior from the external surroundings, the first pane can face the interior or the external surroundings.

The first pane and the second pane preferably contain or are made of glass, particularly preferably flat glass, float glass, quartz glass, borosilicate glass, soda lime glass, aluminosilicate glass, or clear plastics, preferably rigid clear plastics, in particular polyethylene, polypropylene, polycarbonate, polymethyl methacrylate, polystyrene, polyamide, polyester, polyvinyl chloride, and/or mixtures thereof.

The first pane and the second pane can have further suitable coatings known per se, for example, antireflection coatings, nonstick coatings, scratch-resistant coatings, photocatalytic coatings, electrically conductive coatings, or sun-shading coatings or low-E coatings.

The thickness of the individual panes (first pane and second pane) can vary widely and be adapted to the requirements of the individual case. Preferably, panes with the standard thicknesses from 0.5 mm to 5 mm and preferably from 1.0 mm to 2.5 mm are used. The size of the panes can vary widely and is governed by the use. The composite pane can have any three-dimensional shape desired. Preferably, the first pane and the second pane have no shadow zones such that they can, for example, be coated by cathodic sputtering. Preferably, the first pane and the second pane are flat or slightly or strongly curved in one or a plurality of spatial directions.

According to the invention, the first pane and the second pane are preferably transparent. In the context of the present invention, “transparent” means that the total transmittance of the composite pane complies with the legal requirements for windshields (for example, the directives of the European Union ECE-R43) and preferably has transmittance for visible light of more than 50% and in particular of more than 60%, for example, more than 70%. Thus, “transparent pane” means that the first pane and the second pane are transparent such that through-vision through a through-vision region of the composite pane meets the legal requirements for the desired use, for example, for windshields. Accordingly, “opaque” means light transmittance of less than 10%, preferably less than 5%, and in particular 0%.

When a layer is based on a material, the layer consists for the most part of this material, in particular substantially of this material in addition to any impurities or dopants.

The thermoplastic intermediate layer (adhesive layer) contains or is made of at least one thermoplastic, preferably polyvinyl butyral (PVB), ethylene vinyl acetate (EVA), and/or polyurethane (PU) or copolymers or derivatives thereof, optionally in combination with polyethylene terephthalate (PET). The thermoplastic intermediate layer can, however, also contain, for example, polypropylene (PP), polyacrylate, polyethylene (PE), polycarbonate (PC), polymethyl methacrylate, polyvinyl chloride, polyacetate resin, casting resin, acrylate, fluorinated ethylene-propylene, polyvinyl fluoride, and/or ethylene tetrafluoroethylene, or a copolymer or mixture thereof.

The thermoplastic intermediate layer is preferably implemented as at least one thermoplastic composite film and contains or is made of polyvinyl butyral (PVB), particularly preferably of polyvinyl butyral (PVB) and additives known to the person skilled in the art, such as plasticizers. Preferably, the thermoplastic intermediate layer contains at least one plasticizer. Plasticizers are chemical compounds that make plastics softer, more flexible, smoother, and/or more elastic. They shift the thermoelastic range of plastics to lower temperatures such that the plastics have the desired more elastic properties in the range of the temperature of use. Preferred plasticizers include, for example, carboxylic acid esters, in particular low-volatility carboxylic acid esters, fats, oils, soft resins, and camphor.

Preferably, the thermoplastic intermediate layer based on PVB contains at least 3 wt.-%, preferably at least 5 wt.-%, particularly preferably at least 20 wt.-%, even more preferably at least 30 wt.-%, and in particular at least 35 wt.-% of a plasticizer. The plasticizer contains or is made, for example, of triethylene glycol-bis-(2-ethyl hexanoate).

The thermoplastic intermediate layer can be formed by a single film or, also, by more than one film. The thermoplastic intermediate layer can be formed by one or more thermoplastic films arranged flat one above another, with the thickness of the thermoplastic intermediate layer preferably being from 0.25 mm to 1 mm, typically 0.38 mm or 0.76 mm.

The thermoplastic intermediate layer can also be a functional thermoplastic intermediate layer, in particular an intermediate layer with acoustically damping properties, an infrared-radiation-reflecting intermediate layer, an infrared-radiation-absorbing intermediate layer, and/or a UV-radiation-absorbing intermediate layer. For example, the thermoplastic intermediate layer can also be a band filter film that blocks out narrow bands of visible light.

The invention further includes a projection assembly, comprising a composite pane according to the invention as described above in various embodiments, wherein the composite pane has a mirror structure with electrically switchable optical properties. The projection setup further includes an image display device associated with the composite pane and having an image display directed at the composite pane, wherein the image display device is directed at the composite pane and irradiates it with light, in particular p-polarized light, and wherein at least the region of the composite pane which at least partially includes the mirror structure is irradiated by the image display device.

The indication of the polarization direction refers to the plane of incidence of the radiation on the composite pane. The expression “p-polarized radiation” refers to radiation whose electric field oscillates in the plane of incidence. “S-polarized radiation” refers to radiation whose electric field oscillates perpendicular to the plane of incidence. The plane of incidence is generated by the vector of incidence and the surface normal of the composite pane in the geometric center of the irradiated region.

Preferably, according to the invention, the mirror structure reflects more than 10%, preferably at least 30% or more, preferably 50% or more, and in particular 70% or more, of the light incident on the mirror structure, in particular p-polarized light, preferably in a wavelength range from 450 nm to 650 nm and angles of incidence from 50 to 80°, for example, from 55° to 75°. This is advantageous in order to achieve the greatest possible brightness of an image emitted by the image display device and reflected on the mirror structure.

The term “p-polarized light” means light from the visible spectral range that consists primarily of light with p-polarization. The p-polarized light preferably has a light proportion with p-polarization of ≥50%, preferably of ≥70%, and particularly preferably of ≥90% and in particular of approx. 100%.

The image display device as a light source is used to emit an image. A projector, a display, or or even a different device known to the person skilled in the art can be used as an image display device. Preferably, the image display device is a display, particularly preferably an LCD, LED display, OLED display, or electroluminescent display, in particular an LCD. Displays have a low installation height and can thus be integrated easily and space-savingly into the dashboard of a vehicle. In addition, displays are significantly more energy efficient to operate compared to projectors. The comparatively low brightness of displays is fully sufficient in combination with the mirror structure according to the invention and the opaque cover layer positioned behind it. The radiation of the image display device preferably strikes the composite pane in the region of the mirror structure at an angle of incidence of 55° to 80°, preferably of 62° to 77°. The angle of incidence is the angle between the incidence vector of the radiation of the image display device and the surface normal in the geometric center of the reflection layer.

The invention also includes a vehicle, in particular a passenger car, with a composite pane according to the invention.

The invention can further include a method for production of a composite pane according to the invention. The method comprises at least the steps:
Providing the first pane, the thermoplastic intermediate layer, the mirror structure, and the second pane,
Arranging the first pane, the thermoplastic intermediate layer, the mirror structure, and the second pane, wherein the thermoplastic intermediate layer is arranged between the first pane and the second pane and the mirror structure is arranged on the first surface (IV) of the first pane facing away from the thermoplastic intermediate layer or between the first pane and the second pane,
Laminating the layer stack to form a composite pane.

The layer stack is laminated ander the action of heat, vacuum, and/or pressure, with the individual layers joined to one another (laminated) by at least one thermoplastic intermediate layer. Methods known per se can be used to produce a composite pane. For example, so-called autoclave methods can be carried out at an elevated pressure of approx. 10 bar to 15 bar and temperatures from 130° C. to 145° C. for roughly 2 hours. Vacuum bag or vacuum ring methods known per se operate, for example, at roughly 200 mbar and 130° C. to 145° C. The first pane, the second pane, and the thermoplastic intermediate layer can also be pressed in a calender between at least one pair of rollers to form a composite pane. Facilities of this type for producing composite panes are known and normally have at least one heating tunnel upstream from a press. The temperature during the pressing operation is, for example, from 40° C. to 150° C. Combinations of calendering and autoclave methods have proved particularly useful in practice. Alternatively, vacuum laminators can be used. These consist of one or more heatable and evacuable chambers in which the outer pane and the inner pane can be laminated within, for example, about 60 minutes at reduced pressures from 0.01 mbar to 800 mbar and temperatures from 80° C. to 170° C.

In an advantageous embodiment of the method, after the lamination of the layer stack, a protective layer in the form of a hydrophobic film is applied, for example, by liquid application, for example, by spraying, dipping, flooding, or even by application with a cloth. The application of the hydrophobic film can alternatively also be carried out, for example, as a nanolayer layer system, by chemical or physical vapor deposition methods. According to the invention, the hydrophobic film forms the outer, exposed surface of the composite pane toward the interior, at least in the region of the mirror structure.

The present invention further includes use of the composite pane according to the invention in means of locomotion for travel on land, in the air, or on water, in particular in trains, watercraft, and motor vehicles, for example, as a windshield, roof panel, rear window, and/or side window. Use of the composite pane as a vehicle windshield is preferred. The composite pane according to the invention can also be used as a functional and/or decorative individual piece and as a built-in part in furniture, appliances, and buildings.

Within the scope of the present invention, all embodiments that are mentioned for individual features can also be freely combined with one another provided they are not contradictory.

In the following, the invention is explained in greater detail with reference to figures and exemplary embodiments. The figures are schematic representations and are not to scale. The figures in no way restrict the invention.

They depict:

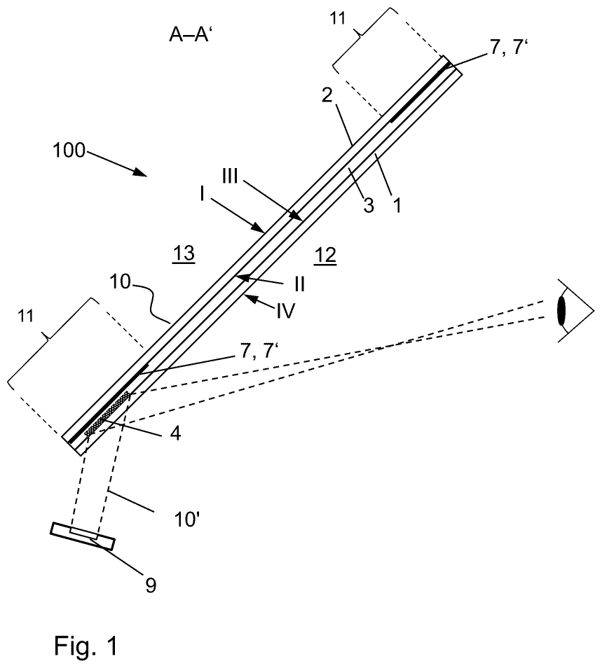

FIG. 1 a cross-sectional view of an embodiment of the projection assembly according to the invention,

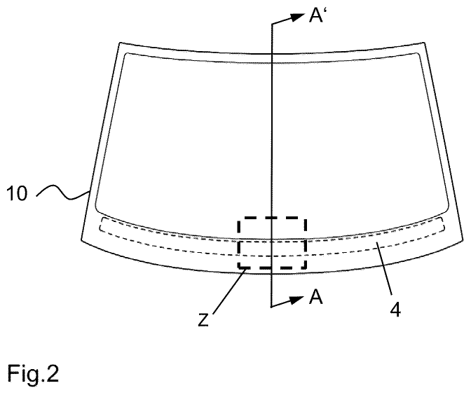

FIG. 2 a plan view of a composite pane of FIG. 1,

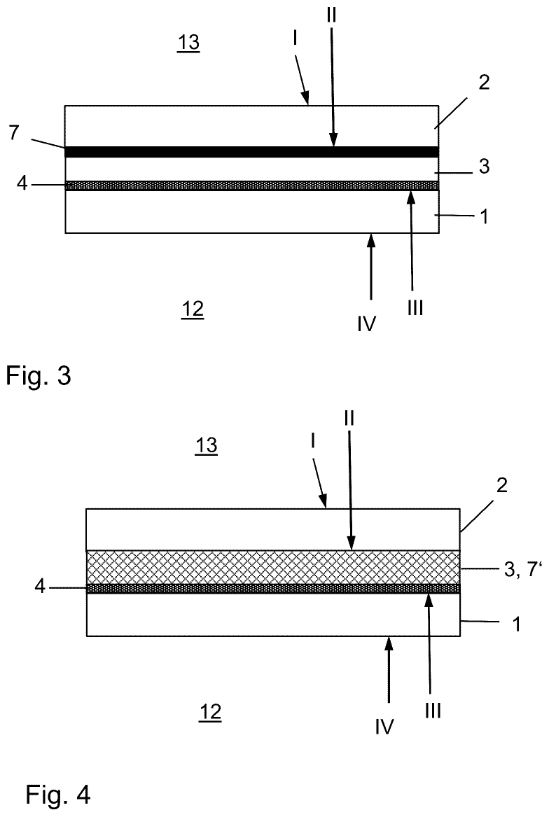

FIG. 3 a cross-sectional view of a first embodiment of the composite pane according to the invention in the region of of a mirror structure,

FIG. 4 a cross-sectional view of a second embodiment of the composite pane according to the invention,

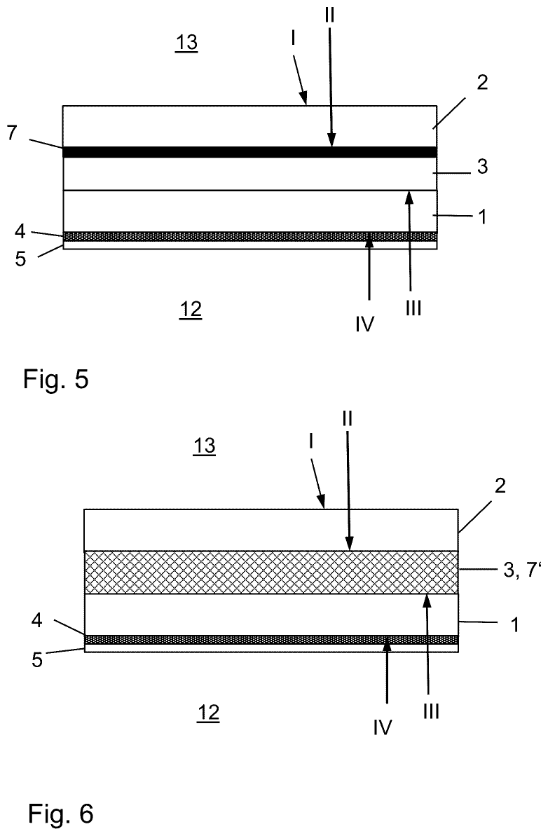

FIG. 5 a cross-sectional view of a third embodiment of the composite pane according to the invention,

FIG. 6 a cross-sectional view of a fourth embodiment of the composite pane according to the invention,

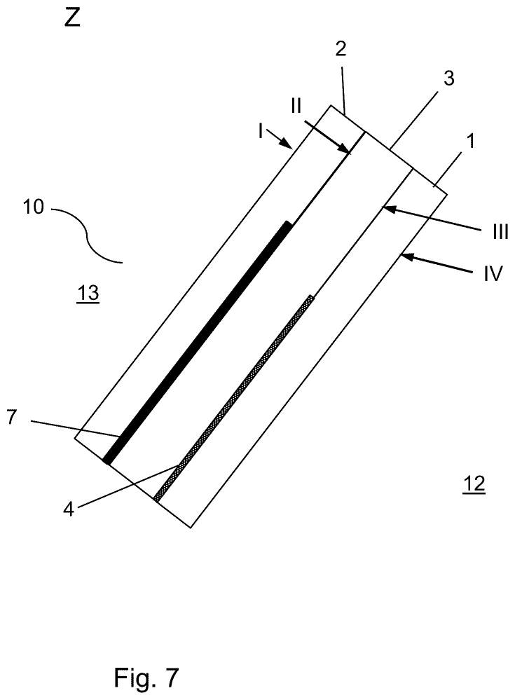

FIG. 7 an enlarged cross-sectional view of the first embodiment of the composite pane according to the invention in the region Z, and

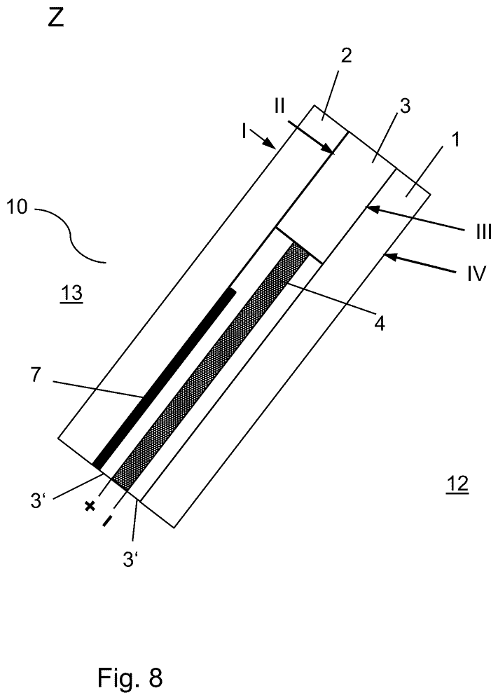

FIG. 8 an enlarged cross-sectional view of a further embodiment of the composite pane according to the invention.

Data with numerical values are generally not to be understood as exact values, but also include a tolerance of +/−1% up to +/−10%.

FIG. 1 depicts a cross-sectional view of an embodiment of the projection assembly 100 according to the invention in a vehicle. The schematic representation is highly simplified. The cross-sectional view of FIG. 1 corresponds to the section line A-A′ of the composite pane 10 of FIG. 2.

A plan view of the composite pane 10 is shown in FIG. 2. Various embodiments of the composite pane 10 are shown in FIG. 3 through 8. The composite pane 10 comprises a first pane 1 and a second pane 2 with a thermoplastic intermediate layer 3. The thermoplastic intermediate layer 3 joins the first pane 1 to the second pane 2. In an installed state, the composite pane 10 is a glazing unit of a vehicle or of a building. The composite pane 10 separates an interior 12 from external surroundings 13. The composite pane 10 is, for example, the windshield of a motor vehicle.

The first pane 1 and the second pane 2 are made in each case of glass, preferably thermally toughened soda lime glass and are transparent to visible light. The thermoplastic intermediate layer 3 consists of a thermoplastic, preferably polyvinyl butyral (PVB), ethylene vinyl acetate (EVA), and/or polyethylene terephthalate (PET).

The first pane 1 has a first surface IV facing away from the thermoplastic intermediate layer and a second surface III facing the thermoplastic intermediate layer. Likewise, the second pane 2 has a first surface II facing the thermoplastic intermediate layer and a second surface I facing away from the thermoplastic intermediate layer. The first surface II of the second pane 2 and the second surface III of the first pane 1 thus also face the intermediate layer 3 in each case. The second surface I of the second pane 2 is the exterior surface of the composite pane 10. The first surface IV of the first pane 1 is the interior surface of the composite pane 10.

The composite pane 10 further has, on the second pane 2, a frame-like circumferential masking strip 7, 7′. The masking strip 7,7′ is opaque, preferably black. The masking strip 7, 7′ is for covering the gluing and connection structures arranged to the interior-side of the composite pane 10. The masking strip 7, 7′ can also be widened in the lower section of the edge region 11 (for example, on the engine side). For this purpose, the section of the edge region 11 has a greater width than in the upper section of the edge region 11 of the composite pane 10 (for example, on the roof side). “Width” means the dimension of the masking strip 7, 7′ perpendicular to its extension.

The composite pane 10 includes a mirror structure 4 situated on the first pane 1 and spatially in front of the masking strip 7, 7′. The opaque masking strip 7, 7′ acts as an opaque background. The mirror structure 4 is, for example, a mirror film, with the masking strip 7,7′ completely covering the mirror film. The mirror structure 4 is electrically switchable. In particular, the mirror structure 4 has reflecting properties that are electrically switchable. For this purpose, the mirror structure 4 can have two flat control electrodes. In other words, the reflectivity of the mirror structure 4 in a first operating mode can be different than in a second operating mode. The mirror structure 4 can be switched from an, in particular, optically transparent state (i.e., a “non-mirroring” state) to a semitransparent state or a reflecting state (mirroring state). The semitransparent state is an intermediate state between the transparent and the reflecting state such that the mirror structure 4 is dimmable. When the composite pane 10 is irradiated with images in the region of the mirror structure 4, these images are reflected. In front of the opaque masking strip 7, 7′, the images reflected by the mirror structure 4 appear bright and readily recognizable.

The mirror structure 4 is arranged on the first pane 1. The mirror structure 4 can be arranged between the first pane 1 and the thermoplastic intermediate layer 3. Alternatively, the mirror structure 4 can be attached on the first surface (IV) of the first pane 1.

The mirror structure 4 is arranged in an edge region 11 in the vicinity of the lower edge of the composite pane 10. A distance of the mirror structure 4 from an edge of the first pane 1 can be 6 cm, 8 cm, or 10 cm. Alternatively, or additionally, the mirror structure 4 can be arranged in the upper section of the edge region 11 or on a lateral section of the edge region 11. An edge arrangement is, of course, advantageous and expedient in an application and embodiment of the composite pane 10 as a windshield, in order to meet the requirements for the field of vision of the driver. The mirror structure 4 can be contiguously flat, in particular in one piece. The mirror structure 4 can extend along an, in particular, lower edge of the composite pane 10 such that a circumferential image (from one side edge to an opposite side edge) can be generated. Or the mirror structure 4 extends in multiple, for example, three or four, sections that are arranged in the lower (for example, engine side) edge region 11.

The projection assembly 100 further includes an image display device 9 as an image generator. The image display device 9 can be arranged in the dashboard of a vehicle and can irradiate the composite pane 10 with images. It is used to generate light, in particular p-polarized light 10′ that is directed at the composite pane 10 and the mirror structure 4. The mirror structure 4 reflects the light 10′, for example, into the vehicle interior, where it can be seen by a viewer (e.g., driver). Thus, important vehicle data (speed, engine speed, route guidance information) can be displayed to the driver in a particularly high-contrast manner.

The light 10′ of the image display device 9 preferably strikes the composite pane 10 at an angle of incidence from 50° to 80°, in particular from 55° to 75°, for example, from 60° to 70°, typically roughly 65°. Alternatively, or additionally, the image display device 9 can be arranged in the A-pillar of a motor vehicle or on the roof in the vehicle interior. When multiple mirror structures 4 are provided, a separate image display device 9 can be associated with each mirror structure 4, i.e., multiple image display devices 9 can be arranged. The image display device 9 is, for example, a display, such as an LCD display, OLED display, EL display, or μLED display. It would also be possible, for example, for the composite pane 10 to be a roof panel, side pane, or rear pane of a vehicle.

FIG. 2 depicts a plan view of a composite pane 10 of FIG. 1. In the plan view of FIG. 2, the mirror structure 4 is arranged extending along the lower section of the edge region 11 of the composite pane 10.

In this embodiment depicted, the mirror structure 4 is in direct contact with the second surface (III) of the first pane 1. The mirror structure 4 is implemented in one piece. Alternatively, the mirror structure 4 can be divided into multiple sections. The number of sections can vary widely. The mirror structure 4 can be divided into 2, 4, 6, or 8 sections.

FIG. 3 depicts a cross-sectional view of a first embodiment of the composite pane 10 in the region of the mirror structure 4. The cross-sectional view of FIG. 3 corresponds to the section line A-A′ (FIG. 2) in the region of the mirror structure 4. The masking strip 7 is applied on the first surface II of the second pane 2, preferably as a ceramic black print. In the first embodiment, the masking strip 7 consists of a coating containing an opaque electrically nonconductive material, for example, a black-colored screen print ink that is baked.

In this embodiment, the mirror structure 4 and the masking strip 7 are separated from one another by the thermoplastic intermediate layer 3. The distance between the mirror structure 4 and the masking strip 7 can be less than 3 mm, for example, 0.76 mm or 0.38 mm. Very clear reflection images are obtained with a distance of less than 3 mm.

FIG. 4 depicts a second embodiment of the composite pane 10. The cross-sectional view of FIG. 4 corresponds to the section line A-A′ (FIG. 2) in the region of the mirror structure 4. In contrast with the design in FIG. 3, the masking strip 7′ (opaque background of the mirror structure 4) is not formed by a black print on the first surface (II) of the second pane 2, but is implemented as a colored thermoplastic intermediate layer 3, for example, a colored or tinted PVB film. One or a plurality of black prints can advantageously be used as further additional layers as masking for adhesive bonds (not shown here).

FIG. 5 depicts a third embodiment of the composite pane 10. The cross-sectional view of FIG. 5 corresponds to the section line A-A′ (FIG. 2) in the region of the mirror structure 4. In contrast to the embodiment in FIG. 3, the mirror structure 4 is not situated between the first pane 1 and the thermoplastic intermediate layer 3, but on the first surface IV of the first pane 1.

Furthermore, the mirror structure 4 is arranged spatially in front of the masking strip 7. A protective layer 5 is arranged on the surface of the mirror structure 4 facing the interior 12. The protective layer 5 seals the surface of the mirror structure 4 against the surrounding atmosphere. The protective layer 5 provided thus forms, at least in the region of the mirror structure 4, the first outer surface of the composite pane 10 directed toward the interior in the installed position and advantageously protects it as well as the mirror structure 4 against external influences and contamination. The protective layer 5 can be implemented as a hydrophobic film, which is a coating with good resistance to deposits of, for example, liquids, salts, greases, and dirt. For example, the formation of fingerprints when touched by a user can be avoided.

FIG. 6 depicts a fourth embodiment of the composite pane 10. The cross-sectional view of FIG. 6 corresponds to the section line A-A′ (FIG. 2) in the region of the mirror structure 4. In contrast to the embodiment in FIG. 4, the mirror structure 4 is not situated between the first pane 1 and the thermoplastic intermediate layer 3, but on the first surface (IV) of the first pane 1. In this example, the masking strip 7′ (opaque background of the mirror structure 4) is not formed by a black print on the first surface (II) of the second pane 2, but by a colored thermoplastic intermediate layer 3, for example, a colored or tinted PVB film. One or a plurality of black prints can advantageously serve as further additional layers as masking for gluing (not shown here).

In this embodiment, the mirror structure 4 and the masking strip 7′ are separated from one another by the first pane 1.

FIG. 7 depicts an enlarged cross-sectional view of the first embodiment of the composite pane 10 according to the invention in the region Z. In this embodiment, the mirror structure 4 provided on the second surface III of the first pane 1 (inner pane, for example) as well as the masking strip 7 applied in this region as an opaque background are preferably limited only locally on the lower edge region 11 of the composite pane 10 and do not affect the through-vision region of the composite pane 10. The masking strip 7 is applied on the first surface II of the second pane 2, preferably as a ceramic black print. Because of the fact that the mirror structure 4 is positioned on the second surface III of the first pane 1, it is protected there against environmental influences and contamination.

FIG. 8 depicts an enlarged cross-sectional view of a further embodiment of the composite pane 10 according to the invention in the region Z. A first thermoplastic intermediate layer 3 fixedly joins the first pane 1 to the second pane 2. The mirror structure 4 provided on the second surface III of the first pane 1 (inner pane, for example) is joined via a further, second thermoplastic intermediate layer 3′ to the first pane 1. In the edge region 11, the second pane 2 is joined to the mirror structure 4 via the masking strip 7 and via a further, third thermoplastic intermediate layer 3′. The thermoplastic intermediate layers 3 and 3′ are made of a thermoplastic, preferably polyvinyl butyral (PVB), ethylene vinylacetate (EVA), and/or polyethylene terephthalate (PET).

The mirror structure 4 is laminated into the two thermoplastic intermediate layers 3′ between the two individual panes 1 and 2, as a result of which the mirror layer 4 is well protected against external influences. The lamination of the mirror structure 4 can be carried out with the lamination of the individual panes of a composite pane. The electrical contacting, like the connection to the energy source of the mirror structure 4, is made by suitable connection cables, for example, flat conductors or foil conductors. The electrical connection points of the mirror structure 4 can be electrically conductively connected to a control unit (ECU) outside the composite pane 10. The control unit is then designed to apply an electrical voltage for controlling the mirror structure 4.

The masking strip 7 is applied on the first surface Il of the second pane 2, preferably as a ceramic black print. In this embodiment, the masking strip 7 consists (analogous to FIG. 3) of a coating containing an opaque material, for example, a black colored screen printing ink that is baked. In this embodiment of the composite pane 10, the masking strip 7 applied in this region as an opaque background is limited such that the mirror structure 4 protrudes beyond the region of the masking strip 7.

Images and displays reflected on the composite pane 10 according to the invention as a glazing unit stand out from it in high contrast, improving the legibility of the operating data and images and, consequently, traffic safety is increased.

### LIST OF REFERENCE CHARACTERS

1 first pane
2 second pane
3, 3′ thermoplastic intermediate layer
4 mirror structure
5 protective layer
7, 7′ masking strip
10 composite pane
10′ light
11 edge region
12 interior
13 external surroundings
100 projection assembly
I second surface (outer side) of the second pane 2
II first surface (inner side) of the second pane 2
III second surface (outer side) of the first pane 1
IV first surface (inner side) of the first pane 1
A-A′ section line
Z enlarged region

1. A composite pane for a projection assembly, at least comprising:
a first pane, a second pane, a thermoplastic intermediate layer, wherein the first pane is joined to a second pane via the thermoplastic intermediate layer to form a composite pane, and wherein the first pane has a first surface facing away from the thermoplastic intermediate layer and a second surface facing the thermoplastic intermediate layer, and the second pane has a first surface facing the thermoplastic intermediate layer and a second surface facing away from the thermoplastic intermediate layer, and
a mirror structure with electrically switchable optical properties,
wherein the mirror structure is arranged in front of an opaque masking strip in a through-vision direction through the composite pane.

2. The composite pane according to claim 1, wherein the mirror structure is arranged on the first pane.

3. The composite pane according to claim 1, wherein the mirror structure is arranged between the first pane and the thermoplastic intermediate layer or on the first surface of the first pane.

4. The composite pane according to claim 1, wherein the mirror structure is arranged in an edge region of the composite pane.

5. The composite pane according to claim 1, wherein a distance of the mirror structure from an edge of the first pane is from 0.1 cm to 30 cm.

6. The composite pane according to claim 1, wherein the mirror structure and an opaque masking strip are separated by the thermoplastic intermediate layer and/or by the first pane.

7. The composite pane according to claim 1, wherein a protective layer protecting the mirror structure is provided.

8. The composite pane according to claim 1, wherein the mirror structure is contiguously flat.

9. The composite pane according to claim 1, wherein the mirror structure has alterable reflection.

10. The composite pane according to claim 1, wherein the mirror structure is switchable from a transparent state to a semitransparent state or a reflecting state.

11. The composite pane according to claim 1, wherein the mirror structure is implemented as a mirror film.

12. The composite pane according to claim 1, wherein the opaque masking strip is implemented as a coating or as an inserted opaque element.

13. Composite The composite pane according to claim 1, wherein the composite pane is provided as a windshield, roof panel, rear window, and/or side window of a vehicle.

14. A projection assembly, comprising:
a composite pane according to claim 1,
an image display device associated with the composite pane and having an image display directed at the composite pane, wherein the image display device is directed at the composite pane and irradiates it with light and wherein at least a region of the composite pane that at least partially comprises the mirror structure is irradiated by the image display device.

15. A vehicle comprising a composite pane according to claim 1

16. The composite pane according to claim 5, wherein the distance of the mirror structure from the edge of the first pane is from 1 cm to 15 cm.

17. The composite pane according to claim 16, wherein the distance of the mirror structure from the edge of the first pane is from 5 cm to 10 cm.

18. The composite pane according to claim 12, wherein the coating is a ceramic black print, or the inserted opaque element is a film.

19. The projection assembly according to claim 14, wherein the light is a p-polarized light.
